(19) United States
(12) Patent Application Publication
(10) Pub. No.: US 2025/0023307 A1
(43) Pub. Date: Jan. 16, 2025

(54) MULTI-FUNCTIONAL DISTRIBUTOR

(71) Applicant: ShenZhen Jin Chang Da Nonferrous Metals Co.,Ltd., Shenzhen (CN)

(72) Inventor: Benyi Yao, Xinyang (CN)

(21) Appl. No.: 18/581,740

(22) Filed: Feb. 20, 2024

(30) Foreign Application Priority Data
Jul. 13, 2023 (CN) 202321834022.9

(51) Int. Cl. H01R 27/02; H01R 13/405; H01R 13/512; H01R 25/00

(52) U.S. Cl. CPC H01R 27/02; H01R 13/405; H01R 25/003; H01R 13/512

(57) ABSTRACT

The present disclosure discloses a multi-functional distributor, including an extension socket and a power cord. The power cord is provided with at least one socket structure. The present disclosure varies between desktop power supply and power supply under desk, for desktop power supply, power is supplied through an embedded extension socket, and for the power supply under desk, power is supplied through an on-line output port, so that safety hazards caused by wiring and pulling wires can be avoided, and at the same time, there is no need of more than one extension sockets, i.e., electrical transfer of multiple electrical appliances can be realized with only one extension socket.

### CROSS-REFERENCE TO RELATED APPLICATIONS

This is a U.S. patent application which claims the priority and benefit of Chinese Patent Application Number 202321834022.9, filed on Jul. 13, 2023, the disclosure of which is incorporated herein by reference in its entirety.

### TECHNICAL FIELD

The present disclosure relates to the technical field of distributors, and in particular to a multi-functional distributor.

### BACKGROUND

With the development of modern society, a variety of electrical facilities have been widely used in home, office and other private and public places. Therefore, there is also a growing demand for adapter products or devices that can support normal operation of various electrical facilities.

At present, most adapter products and devices are single in function. For example, on the existing adapter products, generally, only socket apertures on the extension socket are capable of transferring power supply, and power cords cannot provide output ports to transfer electrical equipment. Moreover, existing extension sockets generally have long power cords, in a case that multiple appliances share one extension socket, only the use of some electrical appliances can be met, and electrical equipment with a shorter power cord cannot be connected. For example, as for desktop electrical equipment and electrical equipment under desk, when the extension socket is placed on the desktop, it is easier to connect the desktop electrical equipment to the extension socket, but the electrical equipment under desk cannot share the extension socket due to the fact that the power cord is not long enough.

### SUMMARY

In order to overcome the disadvantages and defects in the prior art, the present disclosure aims to provide a multi-functional distributor.

The objective of the present disclosure is realized through the following technical solutions: a multi-functional distributor includes an extension socket and a power cord, the power cord being provided with at least one socket structure, where the socket structure includes a terminal tab holder, the terminal tab holder is provided with two terminal mounting holes, a positive terminal tab is inserted into one of the terminal mounting holes, a negative terminal tab is inserted into an other of the terminal mounting holes, a bottom of the positive terminal tab is horizontally bent from a bottom of the terminal tab holder into a positive welding end, and a bottom of the negative terminal tab is horizontally bent from the bottom of the terminal tab holder into a negative welding end.

As an improvement to the multi-functional distributor of the present disclosure, ends of the positive welding end and the negative welding end are bent into U-shaped bayonets, the U-shaped bayonet of the positive welding end catches a positive lead of the power cord, and the U-shaped bayonet of the negative welding end catches a negative lead of the power cord. The U-shaped bayonets are capable of clamping the positive and negative leads, and after clamping, the leads can be wrapped and clamped by bending without the need to use welding to connect.

As an improvement to the multi-functional distributor of the present disclosure, the socket structure further includes an injection molded housing, the injection molded housing enclosing the terminal tab holder. When positive and negative terminals on the terminal tab holder are connected to the leads well, the power cord is injection molded into a whole together with the terminal tab holder and the injection molded housing.

As an improvement to the multi-functional distributor of the present disclosure, one end of the power cord is provided with a plug and an other end is connected to the extension socket.

As an improvement to the multi-functional distributor of the present disclosure, the extension socket comprises a housing, the housing is internally provided with a terminal mounting plate, a positive\negative terminal series connection plate and a ground terminal plate, the terminal mounting plate is provided with a positive\negative terminal mounting slot, vertical top ribs are provided on two inner side walls of the positive\negative terminal mounting slot, the positive\negative terminal series connection plate is provided with a plurality of positive\negative terminal groups at intervals, and the positive\negative terminal groups are threaded into corresponding to the positive\negative terminal mounting slot.

As an improvement to the multi-functional distributor of the present disclosure, the housing is also internally provided with a circuit board, the circuit board is provided with a DC output port, the DC output port is a USB connector or a TYPE-C output connector, and the power cord is connected to the circuit board, the positive\negative terminal series connection plate and the ground terminal plate.

As an improvement to the multi-functional distributor of the present disclosure, the housing comprises a bottom shell and a face cover, a stud is provided on an inner side surface of the face cover, the bottom shell is provided with a screw hole, the bottom shell and the face cover are fixedly connected with screws, and the face cover is capable of pressing and fixing the positive\negative terminal series connection plate and the ground terminal plate.

The beneficial effects of the present disclosure are as follows: the present disclosure varies between desktop power supply and power supply under desk, for desktop power supply, power is supplied through an embedded extension socket, and for the power supply under desk, power is supplied through an on-line output port, so that safety hazards caused by wiring and pulling wires can be avoided, and at the same time, there is no need of more than one extension sockets, i.e., electrical transfer of multiple electrical appliances can be realized with only one extension socket; and the present disclosure uses the on-line output port which is convenient to connect, and with the welding-free connection, the connection is more solid.

### BRIEF DESCRIPTION OF DRAWINGS

FIG. 1 is a three-dimensional view of the present disclosure.

FIG. 2 is a schematic exploded view of the present disclosure.

FIG. 3 is an exploded view of a socket structure of the present disclosure.

List of numerals: 1, extension socket; 2, power cord; 3, socket structure; 4, plug; 31, terminal tab holder; 32, terminal mounting hole; 33, positive terminal tab; 34, negative terminal tab; 35, positive welding end; 36, U-shaped bayonet; 37, injection molded housing; 11, housing; 12, terminal mounting plate; 13, positive\negative terminal series connection plate; 14, ground terminal plate; 15, positive\negative terminal mounting slot; 16, vertical top rib; 17, positive\negative terminal group; 18, circuit board; 19, DC output port; 111, bottom shell; 112, face cover; and 113, stud.

### DESCRIPTION OF EMBODIMENTS

The technical solutions in the embodiments of the present disclosure will be clearly and completely described below with reference to the accompanying drawings in the embodiments of the present disclosure. Obviously, the embodiments described are merely a part of the embodiments of the present disclosure, not all the embodiments. Based on the embodiments of the present disclosure, all other embodiments obtained by a person of ordinary skill in the art without creative work shall fall within the protection scope of the present disclosure.

It should be noted that all directional indications (such as on, under, left, right, front, rear . . . ) in the embodiments of the present disclosure are only used to explain the relative positional relationship, movement, and the like among the components in a particular attitude (as shown in the accompanying drawings), and that the directional indications are correspondingly changed if the particular attitude is changed.

In addition, the descriptions involving “first” and “second” are only used for the purpose of description, and cannot be understood as indicating or implying relative importance or implicitly indicating the quantity of indicated technical features. Thus, the feature defined with “first” or “second” may explicitly or implicitly include at least one that feature. In addition, the technical solutions between the embodiments may be combined with each other, but it must be on the basis that the person of ordinary skill in the art can implement, and when the combination of technical solutions appears to be contradictory or unachievable, it should be considered that such combination of technical solutions does not exist, and is not within the scope of protection of the present disclosure.

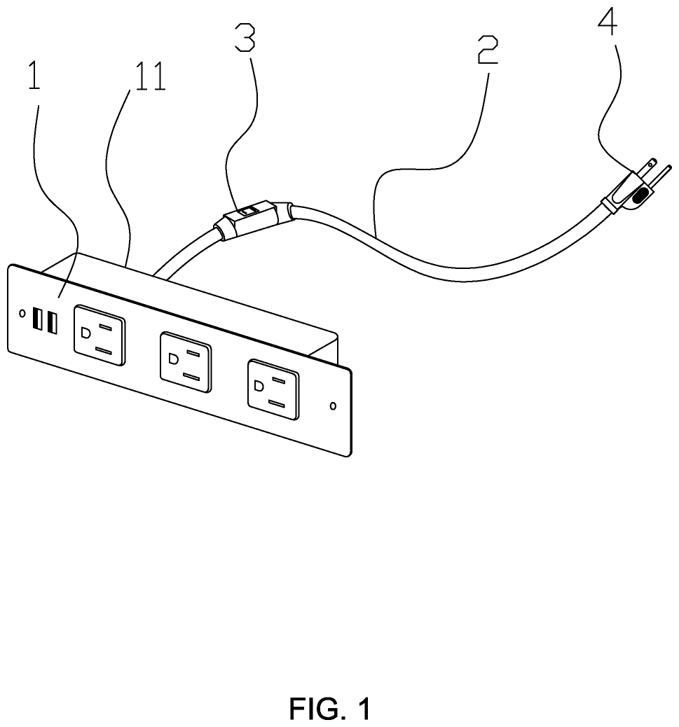

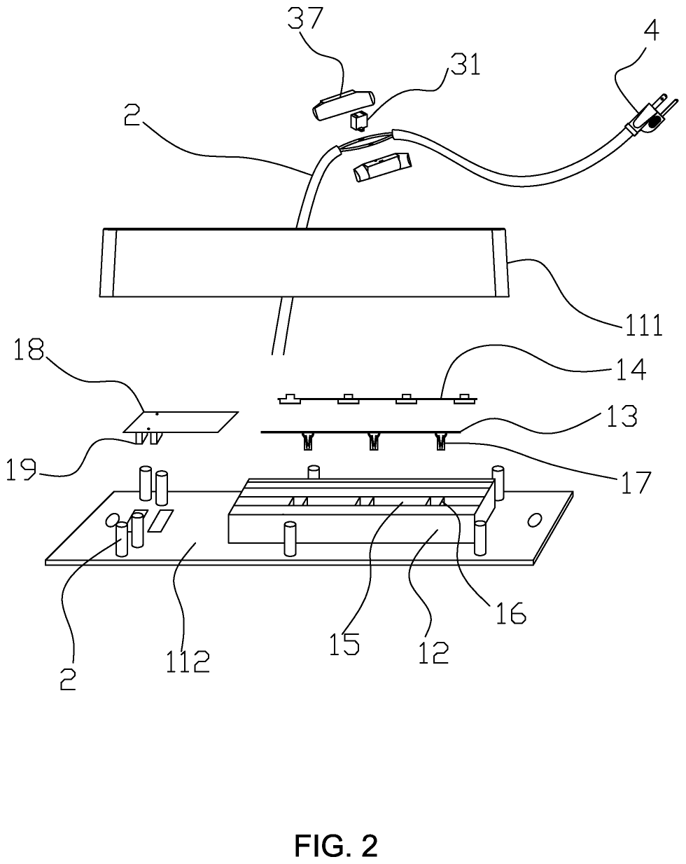

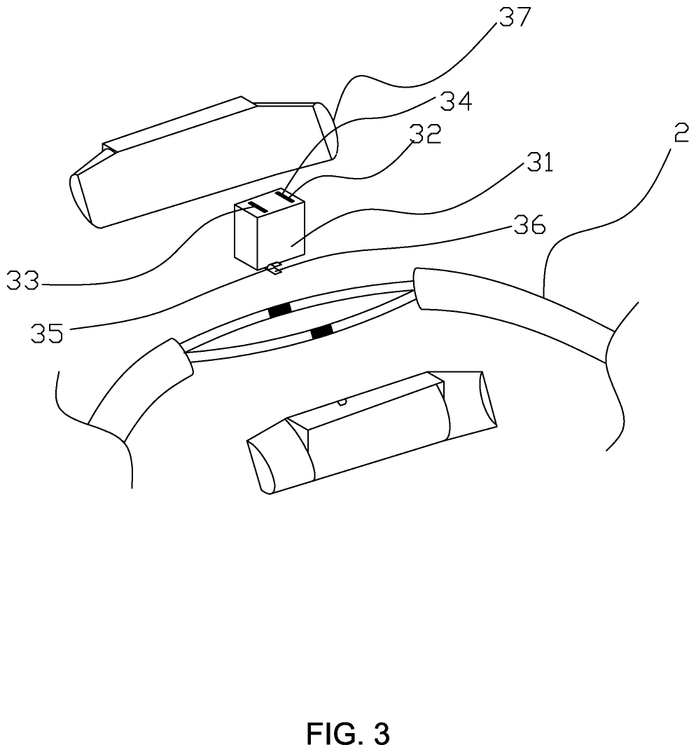

As shown in FIG. 1-FIG. 3, a multi-functional distributor includes an extension socket 1 and a power cord 2. The power cord 2 is provided with at least one socket structure 3. The socket structure 3 includes a terminal tab holder 31. The terminal tab holder 31 is provided with two terminal mounting holes 32. A positive terminal tab 33 is inserted into one of the terminal mounting holes 32. A negative terminal tab 34 is inserted into an other of the terminal mounting holes 32. A bottom of the positive terminal tab 33 is horizontally bent from a bottom of the terminal tab holder 31 into a positive welding end 35. A bottom of the negative terminal tab 34 is horizontally bent from the bottom of the terminal tab holder into a negative welding end.

Preferably, ends of the positive welding end 35 and the negative welding end are bent into U-shaped bayonets 36. The U-shaped bayonet 36 of the positive welding end catches a positive lead of the power cord 2. The U-shaped bayonet 36 of the negative welding end catches a negative lead of the power cord 2. The U-shaped bayonets 36 are capable of clamping the positive and negative leads, and after clamping, the leads can be wrapped and clamped by bending without the need to use welding to connect.

Preferably, the socket structure 3 further includes an injection molded housing 37. The injection molded housing 37 encloses the terminal tab holder 31. When positive and negative terminals on the terminal tab holder 31 are connected to the leads well, the power cord is injection molded into a whole together with the terminal tab holder and the injection molded housing.

Preferably, one end of the power cord 2 is provided with a plug 4 and an other end is connected to the extension socket 1.

Preferably, the extension socket 1 includes a housing 11. The housing 11 is internally provided with a terminal mounting plate 12, a positive\negative terminal series connection plate 13 and a ground terminal plate 14. The terminal mounting plate 12 is provided with a positive\negative terminal mounting slot 15. Vertical top ribs 16 are provided on two inner side walls of the positive\negative terminal mounting slot 15. The positive\negative terminal series connection plate 13 is provided with a plurality of positive\negative terminal groups 17 at intervals. The positive\negative terminal groups 17 are threaded into corresponding to the positive\negative terminal mounting slot 15.

Preferably, the housing 11 is also internally provided with a circuit board 18. The circuit board 18 is provided with a DC output port 19. The DC output port 19 is a USB connector or a TYPE-C output connector. The power cord 2 is connected to the circuit board 18, the positive\negative terminal series connection plate 13 and the ground terminal plate 14.

Preferably, the housing 11 includes a bottom shell 111 and a face cover 112. A stud 113 is provided on an inner side surface of the face cover 112. The bottom shell 111 is provided with a screw hole. The bottom shell 111 and the face cover 112 are fixedly connected with screws. The face cover 112 is capable of pressing and fixing the positive\negative terminal series connection plate 13 and the ground terminal plate 14.

Although the embodiments of the present disclosure have been shown and described, for a person of ordinary skill in the art, it will be understood that various changes, modifications, substitutions and variations can be made to these embodiments without departing from the principle and spirit of the present disclosure, and the scope of the present disclosure is defined by the appended claims and their equivalents.

What is claimed is:

1. A multi-functional distributor, comprising an extension socket and a power cord, the power cord being provided with at least one socket structure, wherein
the socket structure comprises a terminal tab holder, the terminal tab holder is provided with two terminal mounting holes, a positive terminal tab is inserted into one of the terminal mounting holes, a negative terminal tab is inserted into an other of the terminal mounting holes, a bottom of the positive terminal tab is horizontally bent from a bottom of the terminal tab holder into a positive welding end, and a bottom of the negative terminal tab is horizontally bent from the bottom of the terminal tab holder into a negative welding end.

2. The multi-functional distributor according to claim 1, wherein ends of the positive welding end and the negative welding end are bent into U-shaped bayonets, the U-shaped bayonet of the positive welding end catches a positive lead of the power cord, and the U-shaped bayonet of the negative welding end catches a negative lead of the power cord.

3. The multi-functional distributor according to claim 2, wherein the socket structure further comprises an injection molded housing, the injection molded housing enclosing the terminal tab holder.

4. The multi-functional distributor according to claim 1, wherein one end of the power cord is provided with a plug and an other end is connected to the extension socket.

5. The multi-functional distributor according to claim 4, wherein the extension socket comprises a housing, the housing is internally provided with a terminal mounting plate, a positive\negative terminal series connection plate and a ground terminal plate, the terminal mounting plate is provided with a positive\negative terminal mounting slot, vertical top ribs are provided on two inner side walls of the positive\negative terminal mounting slot, the positive\negative terminal series connection plate is provided with a plurality of positive\negative terminal groups at intervals, and the positive\negative terminal groups are threaded into corresponding to the positive\negative terminal mounting slot.

6. The multi-functional distributor according to claim 5, wherein the housing is also internally provided with a circuit board, the circuit board is provided with a DC output port, the DC output port is a USB connector or a TYPE-C output connector, and the power cord is connected to the circuit board, the positive\negative terminal series connection plate and the ground terminal plate.

7. The multi-functional distributor according to claim 6, wherein the housing comprises a bottom shell and a face cover, a stud is provided on an inner side surface of the face cover, the bottom shell is provided with a screw hole, the bottom shell and the face cover are fixedly connected with screws, and the face cover is capable of pressing and fixing the positive\negative terminal series connection plate and the ground terminal plate.
